(19) United States
(12) Patent Application Publication
(10) Pub. No.: US 2014/0375562 A1
(43) Pub. Date: Dec. 25, 2014

(54) System and Process for Human-Computer Interaction Using a Ballistic Projectile as an Input Indicator

(71) Applicant: Daniel Robert Pereira, Millers Creek, NC (US)

(72) Inventor: Daniel Robert Pereira, Millers Creek, NC (US)

(73) Assignee: Daniel Robert Pereira

(21) Appl. No.: 13/924,278

(22) Filed: Jun. 21, 2013

(51) Int. Cl. G06F 3/0354; G06F 3/03

(52) U.S. Cl. CPC G06F 3/0354; G06F 3/0304
USPC 345/158

(57) ABSTRACT

A process for interacting with computer software using a physical ballistic projectile with the steps of: computer sends target image to projector, user shoots projectile at light-blocking shot screen, video imaging device sends video frames to computer for processing by hit detection software, hit detection software compares video frames and identifies a difference as a hit and stores the x,y location of the hit and applies a mirror transform on the x,y coordinates and adjusts the coordinates based on pre-calibrated skewing angles of the video frames, hit detection software verifies that the hit is not moving, ruling out light flicker, debris, or the projectile itself, and computer executes a user input event, such as a mouse click, at the adjusted x,y coordinates.

### CROSS REFERENCE TO RELATED APPLICATIONS

This application is based on provisional application serial number 502724764, filed on Apr. 29, 2012.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of human-computer interaction and more specifically to a system and process for human-computer interaction using a ballistic projectile as an input data indicator.

This system and process was developed to facilitate interaction with computer generated animations using a projectile to indicate the location of an input such as a mouse click or touch event. This system and process allows a user to be presented with images and animations as targets, and it allows the target to change or react based on the location of their projectile hits.

Other modes of detecting a physical (non-light/laser) projectile hits exist, but utilize special hardware such as thermal sensors, acoustic sensors, and infra-red sensors or they require more than one sensing device.

Patents of interest may include:

US 2011/0183299

U.S. Pat. No. 3,849,910

Prior technology for providing human-computer interaction requires specialized hardware sensing devices such as thermal sensors, acoustic sensors, infra-red sensors or they require more than one sensing device. This invention only requires a single, common, webcam to accurately detect hits which differentiates it from prior systems by being much less expensive to implement, service, and maintain. Prior technology also couples hit detection with the simulated target making it impossible for third party developers to create target content for these systems. This invention decouples hit detection and target simulation providing an open system for third-party developers to create any content that reacts to mouse clicks or touch events to use with this system and process.

### BRIEF SUMMARY OF THE INVENTION

The primary object of the invention is this method provides accurate projectile hit detection with no need for specialized hardware, only common off-the-shelf hardware is required: a personal computer, a projector, a web cam, and a shot screen that blocks light such as common corrugated cardboard. Other methods of hit detection require thermal or infra-red cameras, special acoustic modeling equipment, or other uncommon apparatus making those methods more expensive to implement than this method.

Another object of the invention is this method provides human-computer interaction using mouse clicks, or other computer input events such as touch events, to map the projectile hit onto the projected software application. This lets the user operate the software with a projectile as if they were using an input device such as a mouse. This allows the simulation software to be decoupled from the hit detection software. Other methods of hit detection do not raise input events requiring the simulation software to be coupled to the hit detection system.

Another object of the invention is this method can be used indoors or outdoors or in any light condition. Even in pitch black conditions the projector light is detectable by the camera through holes in the shot screen.

A further object of the invention is this method uses a video imaging device placed behind the shot screen, which solves the problem of computer vision/difference detection being falsely triggered by the animated projection on the screen. Other methods either use more expensive imaging hardware or are limited to non-animated content.

Yet another object of the invention is this method works with any projectile with enough velocity to pierce or dent the shot screen. Other methods require lasers, light guns, or other special hardware.

Still yet another object of the invention is this method allows the projectile to be cold and silent such as plastic less-lethal projectiles.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a system and process for human-computer interaction using a ballistic projectile as an input data indicator comprising the steps of: computer sends target image to projector, user shoots projectile at projected target image reflected on light-blocking shot screen, camera sends video frames to computer for processing by hit detection software, computer mathematically corrects camera image skew angle, mirrors the image, and multiplies image resolution to match projector resolution , computer compares image frames to locate target hit's x,y coordinates, computer verifies hit is not light flicker from projector, and computer verifies that the detected difference in frames is not a moving object, and If all conditions from Step 6 are met, the computer raises an input event, such as a mouse click, at the adjusted x,y coordinates.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the system and a list of process steps in a usable physical configuration.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims. Broadly, an embodiment of the present invention provides a system and a process for human-computer interaction using a physical ballistic projectile as an input data indicator.

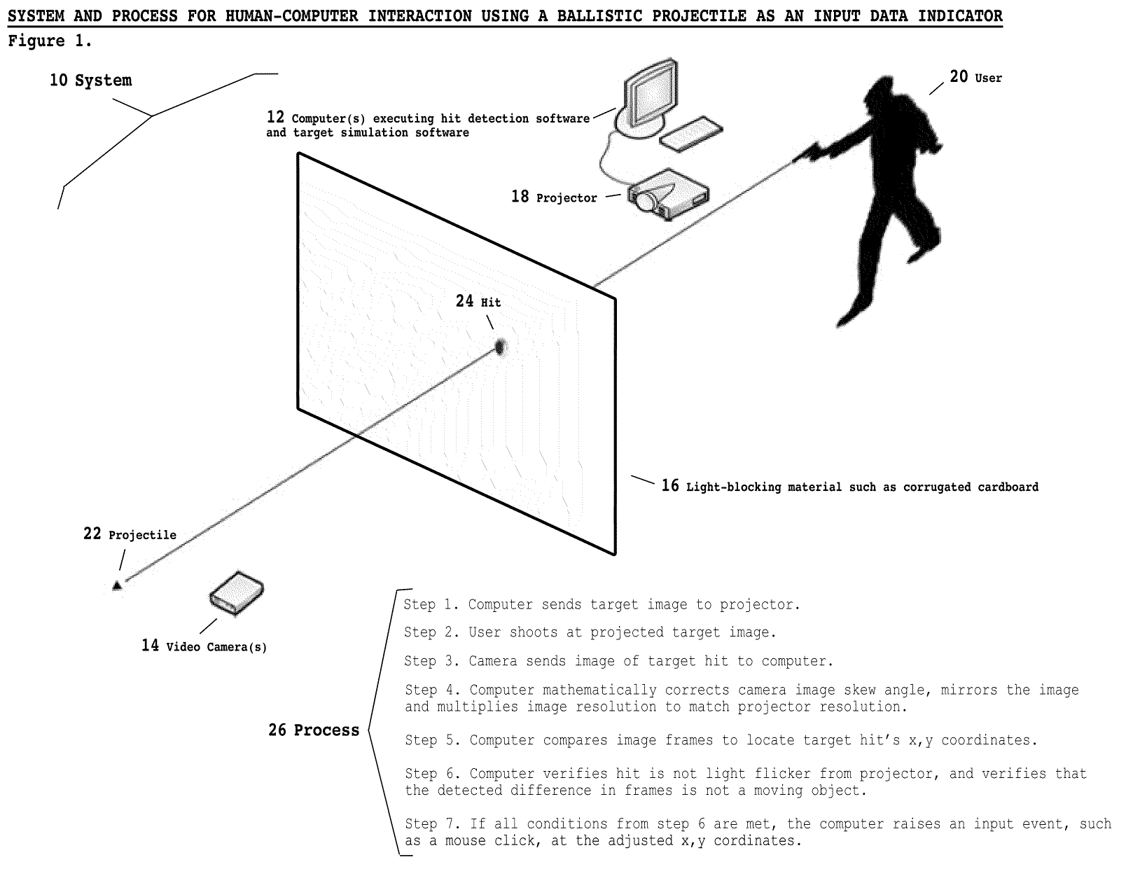

Referring now to the FIG. 1, a system 10 comprising common computer hardware devices and a light-blocking shot screen, such as corrugated cardboard, may include a computer 12, a digital video camera 14, such as a webcam, a target shot screen 16, a projector 18, a user 20, a projectile 22, a detectable hit 24, and a process 26 for mapping a hit 24 to an input event such as a mouse click. The camera 14 may be positioned to have a view of the screen 16, such as behind the screen 16 as illustrated in the FIGURE, but not in a location that is in the possible path of the projectile 22. The system 10 may also include a projector 18 that may project a target image and hit location information onto the screen 16. The camera 14 and projector 18 may be coupled to an interface in the computer 12, such as with 10 cables or through a wireless network. The computer 12 may include memory to store hit detection software instructions and hit processing software instructions to be executed by a processor. In an alternative embodiment, the hit detection software may be stored and executed in separate computers. In use, the camera 14 may be aimed at the screen 16 and the video signal from the camera 14 may be monitored by the hit detection software in the computer 12. The camera 14 and the hit detection software may be calibrated for increased accuracy by using calibration points at the center and other locations on the screen. Calibration adjustments may be made by using test shots until the hit information is accurately collected. Preferably, the resolution of the camera 14 and the projector 18 are the same to provide one-to-one mapping between hit detection and the feedback display. In cases where the camera 14 is a different resolution than the projected image, a multiplier is applied by the hit detection software that effectively scales the hit coordinates accordingly. This is acceptable because the hit 24 generally covers a significant blob of pixels so there is margin for error in the determination of the hit coordinates. In one embodiment that may be used, the camera 14 may be located in front of the screen 16 as long as the projected image is not animated or the camera exposure is set accordingly to only detect the black circles left by the projectile 22 and all other color is washed out preventing the hit detection software from detecting changes in the frames due to animation.

The distinct steps in the process 26 are:

Step 1: Computer 12 sends target image to projector 18.

Step 2: user 20 shoots projectile 22 at projected target image reflected on light-blocking shot screen 16.

Step 3: Camera 14 sends video frames to computer 12 for processing by hit detection software.

Step 4: Computer 12 mathematically corrects camera 14 image skew angle, mirrors the image, and multiplies image resolution to match projector 16 resolution.

Step 5: Computer 12 compares image frames to locate hit's 24 x,y coordinates.

Step 6: Computer 12 verifies hit 24 is not light flicker from projector 18, and computer 12 verifies that the detected difference in frames is not a moving object.

Step 7: If all conditions from Step 6 are met, the computer 12 raises an input event, such as a mouse click, at the adjusted x,y coordinates.

When the user 20 shoots a projectile 22 towards the target, it passes through the screen 16. By comparing pixel differences of one video frame with the previous frame, the hit 24 detection software may detect a change made by the mark on or hole through the screen 16 and may identify the change as a hit 24. Hit information, such as the X-Y coordinates of the location of the hit 24, are adjusted mathematically to correct for skewing, reversal, and resolution dimensions and may be used to raise an input event such as a mouse click or stored for later retrieval or be used to take some action. For example, the hit processing software may send a video signal to the projector 18 which may then project the hit 24 information onto the screen. In one embodiment, the projector may be used to project a target onto the screen. Based on the hit information, the resulting input event, such as a mouse click handled by the software may cause the target image to change, such as the target's location or its shape. The hit detector software may be part of the same software application that renders the target image but may also be separated into separate software, network peers or client/server components, allowing for scalability of the entire system 10. Light shrouds may help hit detection be more accurate in certain highly lit environments, and camera and projector tracks or rails may allow for quicker and more accurate alignment and positioning of the camera 14 and projector 18. A system to roll white set paper over a backboard may allow for automatic resetting of the target screen 16 by effectively hiding holes in the shot screen 16 from previous hits. Previous holes in the shot screen 16 can also be covered with tape, stickers, labels, to effectively reset the previous physical hit 24 area. 3D engine software may enhance the system 10 by allowing 3D applications such as games and training simulations to be used as the target image and be controlled in part by the hit 24 locations or by the user 20. A 3D projector can be used in combination with 3D glasses to provide stereoscopic display images. A motion sensor can be included to allow the computer to track the user's 20 position in space and time relative to the hits detected and provide feedback or corrections on body movement or placement. The system 10 may be used to solve some problems related to live fire applications by allowing the user 20 to be presented with feedback based on the location of the projectile hit 24 on a target. In one set up, shots taken by the user 20 towards a static target may be scored. The system 10 may store a user's 20 hit information in a database and use the information to score the user's 20 performance, calculate his or her best group, and compare one user's interacting performance to another's. In another set up, target images or animations may be displayed and switched based on the detected hit 24 location. For example, an animation of an attacker may be switched to an animation of the attacker falling down when hit. A purely mechanical use may involve a machine that shoots a projectile 22 and adjusts its aim based on feedback from a system implementing this method. This system 10 and process 26 may improve on existing methods by allowing the user 20 to use the weapon and projectile 22 of his or her choice for training and simulation. This method may also allow the use of non-firearm weapons, such as bow weapons, blade weapons, or sling weapons, to be used in training and simulation applications. Because each hit location 24 may be reduced to mathematical coordinates, the computer 12 can use the coordinates to change a projected 10 target, display instant feedback to the user 20, score a hit 24 or series of hits, as well as store the information in a database for later retrieval. This allows a live fire shooting session to be played back and reviewed at a later time. It should be understood, of course, that the foregoing relates to exemplary embodiments of the invention and that modifications may be made without departing from the spirit and scope of the invention as set forth in the following claims

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A system and process for human-computer interaction using a ballistic projectile as an input data indicator comprising the steps of:
computer sends target image to projector;
user shoots projectile at projected target image reflected on light-blocking shot screen;
camera sends video frames to computer for processing by hit detection software;
computer mathematically corrects camera image skew angle, mirrors the image, and multiplies image resolution to match projector resolution;
computer compares image frames to locate target hit's x,y coordinates;
computer verifies hit is not light flicker from projector, and computer verifies that the detected difference in frames is not a moving object; and
If all conditions from Step 6 are met, the computer raises an input event, such as a mouse click, at the adjusted x,y coordinates.
